(19) United States
(12) Patent Application Publication
(10) Pub. No.: US 2025/0124235 A1
(43) Pub. Date: Apr. 17, 2025

(54) USING GENERATIVE ARTIFICIAL INTELLIGENCE TO EVALUATE FINE-TUNED LANGUAGE MODELS

(71) Applicant: ADOBE INC., San Jose, CA (US)

(72) Inventors: Victor Soares BURSZTYN, Mountain View, CA (US); Xiang CHEN, Palo Alto, CA (US); Vaishnavi MUPPALA, San Jose, CA (US); Uttaran BHATTACHARYA, Sunnyvale, CA (US); Tong YU, Fremont, CA (US); Saayan MITRA, San Jose, CA (US); Ryan ROSSI, San Jose, CA (US); Manas GARG, Fremont, CA (US); Kenneth George RUSSELL, Mountain View, CA (US); Eunyee KOH, Sunnyvale, CA (US); Alexandru Ionut HODOROGEA, San Francisco, CA (US)

(21) Appl. No.: 18/485,204

(22) Filed: Oct. 11, 2023

(51) Int. Cl. G06F 40/40; G06F 40/279

(52) U.S. Cl. CPC G06F 40/40; G06F 40/279

(57) ABSTRACT

Methods and systems are provided for using generative artificial intelligence to evaluate fine-tuned language models. In embodiments described herein, natural language text snippets are generated via a generative language model based on corresponding data. A language model is fine-tuned into a fine-tuned language model via a language model fine-tuning component using the natural language text snippets and the corresponding data as training data. Independent natural language text snippets are generated via the generative language model based on the corresponding data. Each independent natural language text snippet is different than each corresponding natural language text snippet. An evaluation metric of the fine-tuned language model is generated via an evaluation component based on the independent natural language text snippets and the corresponding data.

### BACKGROUND

Large language models (“LLMs”) are often utilized due to their capacity to flexibly handle human language. LLMs are often-pre-trained using a large corpus of pre-training data. The LLMs can then be fine-tuned for domain-specific data to perform a specific task using a corpus of domain-specific data. Fine-tuning is typically performed with significantly less data than the pre-training data used to pre-train the LLM. However, as fine-tuning uses significantly less data, there is a concern that the fine-tuned LLM may overfit to the smaller corpus of domain-specific data used to fine-tune the LLM and fail to preserve the capacity to generalize out-of-distribution (“OOD”) natural language variation.

### SUMMARY

Various aspects of the technology described herein are generally directed to systems, methods, and computer storage media for, among other things, using generative artificial intelligence (“AI”) to evaluate fine-tuned language models. In this regard, embodiments described herein facilitate using generative AI to evaluate fine-tuned language models in order to provide a more robust evaluation of fine-tuned language models to natural language variation. For example, different sets of natural language text snippets, such as different sets of natural language queries, can be generated based on the same set of data using different prompts to a generative language model. In this regard, each natural language text snippet of one set of natural language text snippets will use a different natural language variation than each corresponding natural language text snippet of the other set of natural language text snippets regarding the same data. One of the sets of natural language text snippets and corresponding data can be utilized to fine-tune a language and the other set of natural language text snippets with the same corresponding data can be utilized to evaluate the fine-tuned language model. In this regard, by utilizing different natural language text snippets regarding the same set of data used to fine-tune the language model in order to evaluate the fine-tuned language model, the evaluation can provide a more robust evaluation of a fine-tuned language model by generating more realistic measurements of the fine-tuned language model to natural language variation.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIGS. 3A-3D provides example diagrams of using generative AI to evaluate fine-tuned language models, in accordance with embodiments of the present disclosure.

FIG. 4 is a process flow showing a method for implementing using generative AI to evaluate fine-tuned language models, in accordance with embodiments of the present disclosure.

FIG. 5 is a block diagram of an example computing device in which embodiments of the present disclosure can be employed.

### DETAILED DESCRIPTION

### Definitions

Various terms are used throughout the description of embodiments provided herein. A brief overview of such terms and phrases is provided here for ease of understanding, but more details of these terms and phrases is provided throughout.

A “language model” generally refers to an AI system trained to understand and generate human-readable text. “Fine-tuning” refers to the process of adjusting a pre-trained model (e.g., a pre-trained language model) based on specific data to improve the performance of the model for a specific task related to the specific data.

“Semantic textual similarity (“STS”)” refers to a natural language processing (“NLP”) technique to quantify the degree of similarity or relatedness between two pieces of text based on their underlying meaning or semantics. STS typically involves assigning a similarity score to a pair of sentences or documents, with higher scores indicating greater similarity in meaning. STS can include various techniques, including, but not limited to, distributional semantics, word embeddings, and deep learning models.

“Cosine similarity” refers to a metric used to measure the similarity between two non-zero vectors in a multi-dimensional space by calculating the cosine of the angle between the two vectors. Cosine similarity is often used in various NLP techniques, such as document similarity measurement, clustering, recommendation systems, information retrieval, and/or etc.

“Sentence Bidirectional Encoder Representations from Transformers (“SBERT”)” refers to a variation of the Bidirectional Encoder Representations from Transformers (“BERT”) model designed for encoding and comparing sentences or text snippets. SBERT is trained to generate embeddings, which are fixed-length vector representations, for sentences or text snippets. The embeddings generated by SBERT are trained so that semantically similar sentences or text snippets have similar representations in order to use the embeddings for semantic similarity comparison, clustering, retrieval, and/or etc. SBERT typically involves pre-training on a large corpus of text data and then fine-tuning on a specific downstream task to produce sentence embeddings for the particular task, such as sentence pair classification, etc.

A “training set” for fine-tuning a language model refers to a portion of the dataset that is used to teach the language model. A “validation set” for fine-tuning a language model refers to a portion of the dataset that is kept separate from the training data to monitor and fine-tune the model's performance during the training process. A “test set” for fine-tuning a language model refers to a dataset that is used to evaluate the model's performance after fine-tuning. The test set is separate from the training set and the validation set used to fine-tune the language model. In this regard, the test set is utilized to determine how well the model generalizes new, unseen examples. Several types of error measures and evaluation metrics can be output from the test set and/or validation set for fine-tuning and/or evaluating a language model. For example, (1) “accuracy” refers to a metric regarding a language model's performance for overall correctness in generating responses or predictions for a given task or dataset; (2) “precision” refers to a metric regarding a language model's performance to assess the quality of the model's generated; (3) “recall” refers to a metric regarding a language model's performance to retrieve or generate relevant information from a given source or context; (4) “Hit@K” refers to a metric regarding a language model's performance to evaluate the model's performance in ranking a list of items or generating recommendations by measuring whether the correct or relevant item is present within the top “k” recommendations provided by the model; (5) Mean Reciprocal Rank (“MRR”) refers to a metric regarding a language model's performance to rank and retrieves relevant items or documents in response to user queries; (6) Normalized Discounted Cumulative Gain (“NDCG”) refers to a metric regarding a language model's performance to rank and retrieve relevant items or documents in response to user queries by considering both the relevance and position of each item in the ranked list; and/or etc.

“Trigger-generating” refers to causing or initiating the generation of an output or response in response to input, such as an action or event, in order to automate processes in software.

### Overview

Large language models (“LLMs”) have been on the rise due to their capacity to flexibly handle human language. LLMs are often-pre-trained using a large corpus of pre-training data. The LLMs can then be fine-tuned for domain-specific data to perform a specific task using a corpus of domain-specific data. Fine-tuning is typically performed with significantly less data than the pre-training data used to pre-train the LLM. However, as fine-tuning uses significantly less data, there is a concern that the fine-tuned LLM may overfit to the smaller corpus of domain-specific data used to fine-tune the LLM and fail to preserve the capacity to generalize out-of-distribution (“OOD”) natural language variation. Consequently, the fine-tuned LLM may fail to remain robust to expected degrees of natural language variation. Conventional implementations to evaluate the robustness of a fine-tuned LLM to expected degrees of natural language variation require expensive, manual dataset annotation by humans.

Currently, in order to fine-tune and evaluate a language model based on variations of queries, a programmer must manually write each variation of a query or hire/crowdsource other individual to manually write each variation of a query. In this regard, the process of fine-tuning and evaluating a language model based on variations of queries is a manual intensive process requiring the manual writing of each variation of a query before manually checking each variation of the query and then fine-tuning/evaluating the language model based on the manually written variations of the queries. As the corpus of data for fine-tuning and evaluating a language model is often extremely large, the programmer will often forego fine-tuning/evaluating language models based on variations of queries due to the costs and computing resources required.

Accordingly, unnecessary computing resources are utilized by programmers fine-tuning/evaluating language models based on manually written variations of the queries in conventional implementations. For example, computing and network resources are unnecessarily consumed to facilitate the manual intensive process to write each variation of a query and manually check each variation of the query. For instance, computer input/output operations are unnecessarily increased in order for the programmer or the individuals hired/crowdsourced to manually access and review the original data, manually write each query based on the original data, and manually check/review each query for errors or duplications in order to fine-tune/evaluate the language model based on the manually written variations of the queries. In this regard, the manual intensive process to write each variation of a query and manually check each variation of the query is computationally expensive. Further, when the information related to manually access and review the original data, manually write each query based on the original data, and manually check/review each query is located in a disk array, there is unnecessary wear placed on the read/write head of the disk of the disk array each time the information is accessed. Even further, the processing of operations to manually access and review the original data, manually write each query based on the original data, and manually check/review each query decreases the throughput for a network, increases the network latency, and increases packet generation costs when the information is located over a network. In this regard, usage of network resources is multiplied due to the amount of information pertaining to manually access and review the original data, manually write each query based on the original data, and manually check/review each query in order to fine-tune/evaluate the language model based on the manually written variations of the queries.

As such, embodiments of the present disclosure are directed to using generative AI to evaluate fine-tuned language models in an efficient and effective manner. In this regard, different natural language text snippets (e.g., such as queries) generated by a generative language model regarding the same set of data can be efficiently and effectively utilized to fine-tune a language model and provide a more robust evaluation of fine-tuned language models to natural language variation.

Generally, and at a high level, embodiments described herein facilitate using generative AI to evaluate fine-tuned language models in order to provide a more robust evaluation of fine-tuned language models to natural language variation. For example, different sets of natural language text snippets, such as different sets of natural language text queries, can be generated based on the same set of data using different prompts to a generative language model. In this regard, each natural language text snippet of one set of natural language text snippets will use a different natural language variation than each corresponding natural language text snippet of the other set of natural language text snippets regarding the same data. One of the sets of natural language text snippets and corresponding data can be utilized to fine-tune a language and the other set of natural language text snippets with the same corresponding data can be utilized to evaluate the fine-tuned language model. In this regard, by utilizing different natural language text snippets regarding the same set of data used to fine-tune the language model in order to evaluate the fine-tuned language model, the evaluation can provide a more robust evaluation of a fine-tuned language model by generating more realistic measurements of the fine-tuned language model to natural language variation.

In operation, as described herein, a set of natural language text snippets, such as a set of natural language queries, is generated via a generative language model based on a set of data and a prompt. For example, the prompt can include a set of exemplars for the generative language model where each exemplar in includes a keyword, a document corresponding to the keyword, and a natural language query corresponding to the keyword and the document. The set of data can include a set of keywords and a corresponding set of documents related to the keywords. In this regard, the generative language model will generate natural language queries based on the set of data in accordance with the natural language queries of the exemplars.

A language model is fine-tuned into a fine-tuned language model using the set of natural language text snippets (e.g., queries) and the set of data as training data. For example, the set of natural language queries generated by the generative language model can be used along with the corresponding set of documents to fine-tune a language model. In embodiments, some of the natural language queries and corresponding documents are used as training sets to fine-tune the language model and some of the natural language queries and corresponding documents are used as validation sets to fine-tune the language model. In some embodiments, the fine-tuning uses SBERT.

A set of independent natural language text snippets, such as a set of independent natural language queries, is generated via a generative language model based on the set of data, such as through a different generative language model and/or a different prompt. In embodiments, each independent natural language text snippet of the set of independent natural language text snippets is different than each corresponding natural language text snippet of the set of natural language snippets. For example, a prompt that is different than an initial prompt used to generate the set of natural language queries is utilized to generate different natural language queries based on the same set of keywords and corresponding documents as used to generate the initial set of natural language queries to fine-tune language model. For example, the prompt to generate the set of independent natural language queries can include a set of different exemplars for the generative language model where the natural language query of each exemplar is different than the natural language query of each exemplar described used to generate the initial set of natural language queries to fine-tune language model. In this regard, each exemplar can include (1) a keyword corresponding to the same keyword as the exemplar used to generate the initial set of natural language queries to fine-tune language model, (2) a document corresponding to the same document as the exemplar used to generate the initial set of natural language queries to fine-tune language model, and/or (3) a natural language query corresponding to the keyword and the document that is different than the natural language query of the exemplar used to generate the initial set of natural language queries to fine-tune language model. The set of data can include the same set of keywords and corresponding set of documents related to the keywords used to generate the initial set of natural language queries to fine-tune language model. In this regard, as the natural language queries of the exemplars of the prompt are different, the generative language model will generate natural language queries based on the set of data that are different than the natural language queries used to generate the initial set of natural language queries to fine-tune language model.

An evaluation metric of the fine-tuned language model is generated based on the set of independent natural language text snippets (e.g., queries) and the set of data. For example, the evaluation metric can provide the accuracy of the fine-tuned language model with respect to the set of independent natural language queries that are different than the natural language queries that were used to train the model to provide a more realistic measurement of the fine-tuned language model. In this regard, the set of independent natural language queries is utilized along with the set of data as a test set to generate the evaluation metric. The evaluation metric of the fine-tuned language model can include any evaluation metric or combination of evaluation metrics, such as accuracy, precision, recall, Hit@K, MRR, and NDCG, or any other metric regarding the language model.

The evaluation metric can be displayed regarding the fine-tuned language model. For example, the evaluation metric of the fine-tuned language model can be displayed via a user interface component through a display screen of a user device. In this regard, a more realistic measurement of the fine-tuned language model that accounts for natural language variation can be presented to the user so that the user can decide whether to implement the fine-tuned language model or re-train/fine-tune the language model based on further training data.

Advantageously, efficiencies of computing and network resources can be enhanced using implementations described herein. In particular, the automated generating of different natural language text snippets, such as queries, by a generative language model regarding the same set of data can to fine-tune, and provide a more robust evaluation of, a language model to natural language variation provides for a more efficient use of computing resources (e.g., higher throughput and reduced latency for a network, less packet generation costs, etc.) than conventional methods of manually accessing and reviewing the original data, manually writing each query based on the original data, and manually checking/reviewing each query in order to fine-tune/evaluate the language model based on the manually written variations of the queries. The technology described herein results in less operations for the manually accessing and reviewing the original data, manually writing each query based on the original data, and manually checking/reviewing each query over a computer network, which results in higher throughput, reduced latency and less packet generation costs as fewer packets are sent over a network. Therefore, the technology described herein conserves network resources.

### Overview of Exemplary Environments of Using Generative AI to Evaluate Fine-Tuned Language Models

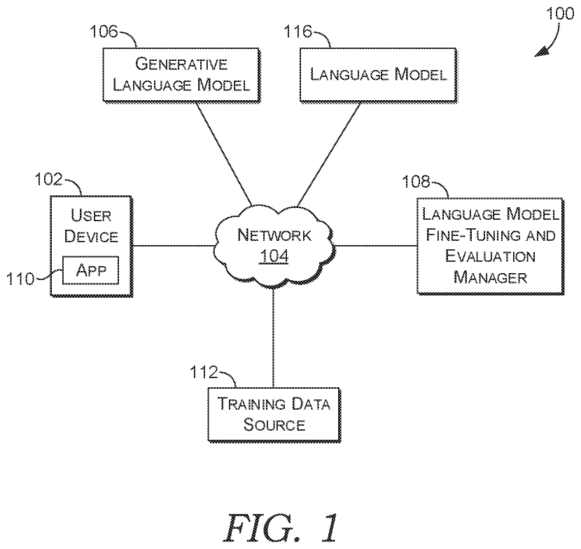

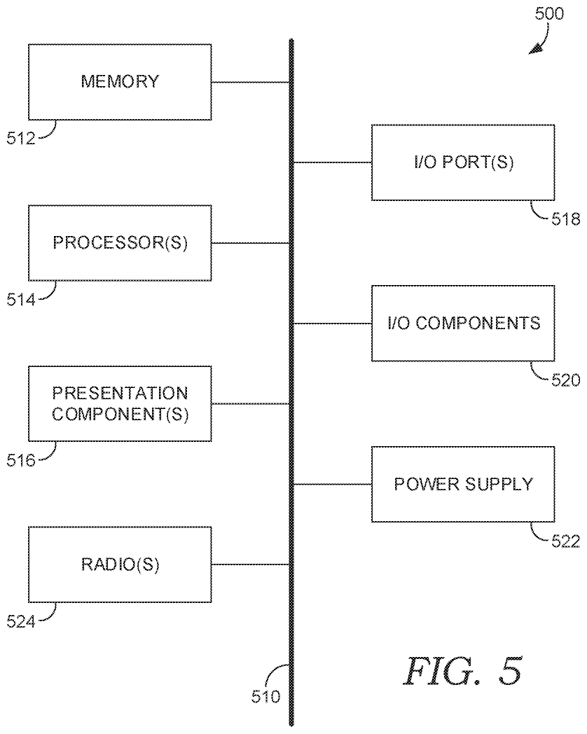

Turning to the figures, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 5.

It should be understood that operating environment 100 shown in FIG. 1 is an example of one suitable operating environment. Among other components not shown, operating environment 100 includes a user device 102, application 110, network 104, generative language model 106, language model 116, and language model fine-tuning and evaluation manager 108. Operating environment 100 also shows training data source 112 that stores training data, for example, to be used to fine-tune the language model 116 for a specific task. Each of the components shown in FIG. 1 can be implemented via any type of computing device, such as one or more of computing device 500 described in connection to FIG. 5, for example.

These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, one or more private networks, one or more cellular networks, one or more peer-to-peer (P2P) networks, one or more mobile networks, or a combination of networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, and other components can be employed within operating environment 100 within the scope of the present disclosure. Each can comprise a single device or multiple devices cooperating in a distributed environment.

User device 102 can be any type of computing device capable of being operated by an individual or entity interested in fine-tuning and/or evaluating a language model. For example, in some implementations, such devices are the type of computing device described in relation to FIG. 5. By way of example and not limitation, user devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media may include computer-readable instructions executable by the one or more processors. The instructions may be embodied by one or more applications, such as application 110 shown in FIG. 1. Application 110 is referred to as single applications for simplicity, but its functionality can be embodied by one or more applications in practice.

Application 110 operating on user device 102 can generally be any application capable of facilitating the presentation of evaluation metrics of language models (e.g., evaluation metric of language model 116 following fine-tuning and evaluation by language model fine-tuning and evaluation manager 108) and user interfaces for the presentation of input/output to language models (e.g., generative language model 106, language model 116, etc.). In some implementations, the application 110 comprises a web application, which can run in a web browser, and could be hosted at least partially server-side (e.g., via generative language model 106, language model 116, and/or language model fine-tuning and evaluation manager 108). In addition, or instead, the application 110 can comprise a dedicated application. In some cases, the application 110 is integrated into the operating system (e.g., as a service).

User device 102 can be a client device on a client-side of operating environment 100, while generative language model 106, language model 116, and/or language model fine-tuning and evaluation manager 108 can be on a server-side of operating environment 100. Generative language model 106, language model 116, and/or language model fine-tuning and evaluation manager 108 may comprise server-side software designed to work in conjunction with client-side software on user device 102 so as to implement any combination of the features and functionalities discussed in the present disclosure. An example of such client-side software is application 110 on user device 102. This division of operating environment 100 is provided to illustrate one example of a suitable environment, and it is noted there is no requirement for each implementation that any combination of user device 102 or language model fine-tuning and evaluation manager 108 to remain as separate entities.

Application 110 operating on user device 102 can generally be any application capable of facilitating the exchange of information between the user device 102 and generative language model 106, language model 116, and/or language model fine-tuning and evaluation manager 108 in fine-tuning and/or evaluating a fine-tuned language model. In some implementations, the application 110 comprises a web application, which can run in a web browser, and could be hosted at least partially on the server-side of environment 100. In addition, or instead, the application 110 can comprise a dedicated application. In some cases, the application 110 is integrated into the operating system (e.g., as a service). It is therefore contemplated herein that “application” be interpreted broadly.

In accordance with embodiments herein, the application 110 facilitates the presentation of a more robust evaluation of fine-tuned language models to natural language variation in an efficient and effective manner. In operation, as described herein, a set of natural language text snippets, such as a set of natural language queries, is generated via generative language model 106 (e.g., Flan-UL2, Falcon-40B, or any generative language model) based on a set of data from training data source 112 and a prompt provided by language model fine-tuning and evaluation manager 108. For example, the prompt can include a set of exemplars for the generative language model where each exemplar in includes a keyword, a document corresponding to the keyword, and a natural language query corresponding to the keyword and the document. The set of data can include a set of keywords and a corresponding set of documents related to the keywords. In this regard, the generative language model 106 will generate natural language queries based on the set of data in accordance with the natural language queries of the exemplars.

Language model 116 is fine-tuned into a fine-tuned language model by language model fine-tuning and evaluation manager 108 using the set of natural language text snippets (e.g., queries) and the set of data as training data. For example, the set of natural language queries generated by the generative language model 106 can be used along with the corresponding set of documents to fine-tune language model 116. In embodiments, some of the natural language queries and corresponding documents are used as training sets to fine-tune the language model 116 and some of the natural language queries and corresponding documents are used as validation sets to fine-tune the language model 116. In some embodiments, the fine-tuning by language model fine-tuning and evaluation manager 108 uses SBERT.

A set of independent natural language text snippets, such as a set of independent natural language queries, is generated via generative language model 106 based on the set of data from training data source 112, such as through a different generative language model and/or a different prompt from language model fine-tuning and evaluation manager 108. In embodiments, each independent natural language text snippet (e.g., query) of the set of independent natural language text snippets (e.g., queries) is different than each corresponding natural language text snippet (e.g., query) of the set of natural language snippets (e.g., queries). For example, a prompt that is different than an initial prompt used to generate the set of natural language queries is utilized to generate different natural language queries based on the same set of keywords and corresponding documents as used to generate the initial set of natural language queries to fine-tune language model. For example, the prompt to generate the set of independent natural language queries can include a set of different exemplars for the generative language model 106 where the natural language query of each exemplar is different than the natural language query of each exemplar described used to generate the initial set of natural language queries to fine-tune language model 116. In this regard, each exemplar can include (1) a keyword corresponding to the same keyword as the exemplar used to generate the initial set of natural language queries to fine-tune language model 116, (2) a document corresponding to the same document as the exemplar used to generate the initial set of natural language queries to fine-tune language model 116, and/or (3) a natural language query corresponding to the keyword and the document that is different than the natural language query of the exemplar used to generate the initial set of natural language queries to fine-tune language model 116. The set of data can include the same set of keywords and corresponding set of documents related to the keywords used to generate the initial set of natural language queries to fine-tune language model 116. In this regard, as the natural language queries of the exemplars of the prompt are different, the generative language model 106 will generate natural language queries based on the set of data that are different than the natural language queries used to generate the initial set of natural language queries to fine-tune language model 116.

An evaluation metric of the fine-tuned language model is generated via language model fine-tuning and evaluation manager 108 based on the set of independent natural language text snippets (e.g., queries) from generative language model 106 and the set of data from training data source 112. For example, the evaluation metric can provide the accuracy of the fine-tuned language model 116 with respect to the set of independent natural language queries that are different than the natural language queries that were used to train the model to provide a more realistic measurement of the fine-tuned language model. In this regard, the set of independent natural language queries is utilized along with the set of data as a test set to generate the evaluation metric via language model fine-tuning and evaluation manager 108. The evaluation metric of the fine-tuned language model 116 can include any evaluation metric or combination of evaluation metrics, such as accuracy, precision, recall, Hit@K, MRR, and NDCG, or any other metric regarding the language model.

The evaluation metric generated by language model fine-tuning and evaluation manager 108 regarding the fine-tuned language model 116 can be displayed through a user interface component of application 110 via a display screen of the user device 102. In this regard, a more realistic measurement of the fine-tuned language model 116 that accounts for natural language variation can be presented to the user so that the user can decide whether to implement the fine-tuned language model or re-train/fine-tune the language model 116 based on further training data.

At a high level, language model fine-tuning and evaluation manager 108 performs various functionality to facilitate efficient and effective using generative AI to evaluate fine-tuned language models in order to provide a more robust evaluation of fine-tuned language models to natural language variation. The language model fine-tuning and evaluation manager 108, generative language model 106, and/or language model 116 can communicate with application 110 in order for application 110 to display the evaluation metrics of language models (e.g., evaluation metric of language model 116 following fine-tuning and evaluation by language model fine-tuning and evaluation manager 108) and user interfaces for the presentation of input/output to language models (e.g., generative language model 106, language model 116, etc.) via a display screen of the user device 102.

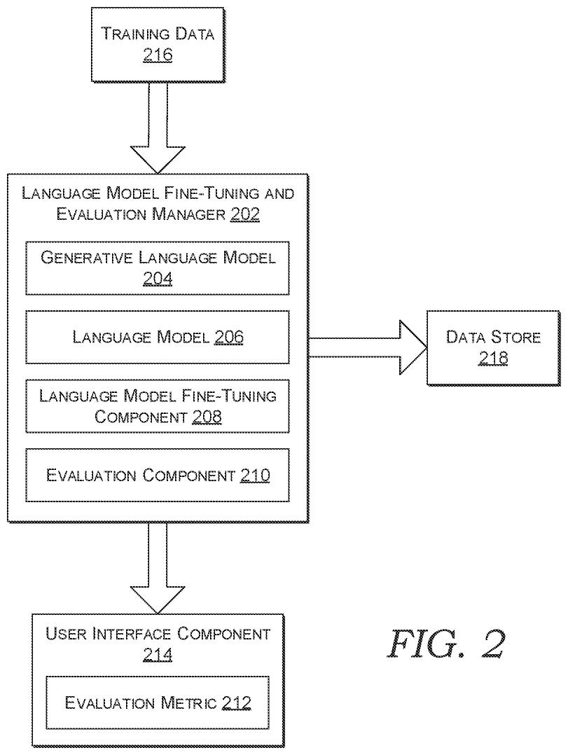

In this regard, language model fine-tuning and evaluation manager 108 can communicate with generative language model 106 and language model 116 in order to fine-tune and/or evaluation language model 116. The language model fine-tuning and evaluation manager 108 facilitates the generation of different natural language generated text (e.g., such as natural language text snippets or queries) by generative language model 106 regarding the same set of data from training data source 112 (e.g., data regarding a specific task to fine-tune language model 116). The language model fine-tuning and evaluation manager 108 facilitates the fine-tuning of language model 116 (e.g., the fine-tuned embeddings of language model 116 can be stored in a data store, such as data store 218 or FIG. 2 using the different natural language generated text generated by generative language model 106.). The language model fine-tuning and evaluation manager 108 facilitates the evaluation using the different natural language generated text generated by generative language model 106.

Language model fine-tuning and evaluation manager 108, generative language model 106, and language model 116 can each be or include a server, including one or more processors, and one or more computer-readable media. The computer-readable media includes computer-readable instructions executable by the one or more processors. The instructions can optionally implement one or more components of language model fine-tuning and evaluation manager 108, generative language model 106, and language model 116, described in additional detail below with respect to language model fine-tuning and evaluation manager 202 of FIG. 2.

For cloud-based implementations, the instructions on language model fine-tuning and evaluation manager 108, generative language model 106, and language model 116 can implement one or more components, and application 110 can be utilized by a user to interface with the functionality implemented on language model fine-tuning and evaluation manager 108, generative language model 106, and language model 116. In some cases, application 110 comprises a web browser. In other cases, language model fine-tuning and evaluation manager 108, generative language model 106, and/or language model 116 may not be required. For example, the components of language model fine-tuning and evaluation manager 108, generative language model 106, and/or language model 116 may be implemented completely on a user device, such as user device 102. In this case, language model fine-tuning and evaluation manager 108, generative language model 106, and/or language model 116 may be embodied at least partially by the instructions corresponding to application 110.

Thus, it should be appreciated that language model fine-tuning and evaluation manager 108, generative language model 106, and language model 116 may be provided via multiple devices arranged in a distributed environment that collectively provide the functionality described herein. Additionally, other components not shown may also be included within the distributed environment. In addition, or instead, language model fine-tuning and evaluation manager 108, generative language model 106, and/or language model 116 can be integrated, at least partially, into a user device, such as user device 102. Furthermore, language model fine-tuning and evaluation manager 108, generative language model 106, and/or language model 116 may at least partially be embodied as a cloud computing service.

Referring to FIG. 2, aspects of an illustrative language model fine-tuning and evaluation management system are shown, in accordance with various embodiments of the present disclosure. At a high level, the language model fine-tuning and evaluation system can facilitate efficient and effective using generative AI to evaluate fine-tuned language models in order to provide a more robust evaluation of fine-tuned language models to natural language variation.

As shown in FIG. 2, language model fine-tuning and evaluation manager 202 includes a generative language model 204, a language model 206, a language model fine-tuning component 208, and an evaluation component 210. Language model fine-tuning and evaluation manager 202 can fine-tune language model 206 (e.g., through language model fine-tuning component 208) based on training data 216 for a specific task (e.g., which may be stored in data store 218) and store the fine-tuned embeddings of the fine-tuned language model in data store 218. Language model fine-tuning and evaluation manager 202 provides evaluation metric 212 for presentation through user interface component 214. The language model fine-tuning and evaluation manager 202 can communicate with the data store 218. The data store 218 is configured to store various types of information accessible by language model fine-tuning and evaluation manager 202, or other server or component. The foregoing components of language model fine-tuning and evaluation manager 202 can be implemented, for example, in operating environment 100 of FIG. 1. In particular, those components may be integrated into any suitable combination of user devices 102, generative language model 106, language model 116, and/or language model fine-tuning and evaluation manager 108. In this regard, user interface component 214 can be any type of user interface (e.g., a display screen/graphical user interface provided via the application 110 on user device 102).

In embodiments, data sources, user devices (such as user device 102 of FIG. 1 and user interface component 214), and language model fine-tuning and evaluation manager 202 can provide data to the data store 218 for storage, which may be retrieved or referenced by any such component. As such, the data store 218 can store computer instructions (e.g., software program instructions, routines, or services), data and/or models used in embodiments described herein, such as data for fine-tuning a language model for a specific task, natural language text generated by generative language model 204, prompts for generative language model 204 generated by language model fine-tuning component 208 and/or evaluation component 210, evaluation metric for a fine-tuned language model generated by evaluation component 210, and/or the like. In some implementations, data store 218 can store information or data received or generated via the various components of language model fine-tuning and evaluation manager 202 and provides the various components with access to that information or data, as needed. The information in data store 218 may be distributed in any suitable manner across one or more data stores for storage (which may be hosted externally).

The generative language model 204 is generally configured to be any type of language model that can generate natural language text based prompts provided by language model fine-tuning component 208 and/or evaluation component 210. The language model 206 is generally configured to be any type of language model that can be fine-tuned (e.g., by language model fine-tuning component 208) and/or evaluated (e.g., by evaluation component 210.)

The language model fine-tuning component 208 is generally configured to fine-tune language model 206 (e.g., based on training data 216 for a specific task and natural language text generated by generative language model 204). In embodiments, language model fine-tuning component 208 can include rules, conditions, associations, models, algorithms, or the like to fine-tune language model 206. Language model fine-tuning component 208 may take on different forms depending on the mechanism used to fine-tune language model 206. For example, language model fine-tuning component 208 may comprise natural language processing techniques, a statistical model, fuzzy logic, neural network, finite state machine, support vector machine, logistic regression, clustering, or machine-learning techniques, similar statistical classification processes, or combinations of these to fine-tune language model 206.

The evaluation component 210 is generally configured to generate an evaluation metric of a fine-tuned language model (e.g., the language model fine-tuned by language model fine-tuning component 206). In embodiments, evaluation component 210 can include rules, conditions, associations, models, algorithms, or the like to generate an evaluation metric of a fine-tuned language model. Evaluation component 210 may take on different forms depending on the mechanism used to generate an evaluation metric of a fine-tuned language model. For example, evaluation component 210 may comprise natural language processing techniques, a statistical model, fuzzy logic, neural network, finite state machine, support vector machine, logistic regression, clustering, or machine-learning techniques, similar statistical classification processes, or combinations of these to generate an evaluation metric of a fine-tuned language model.

In embodiments, a set of natural language text snippets (e.g., queries) is generated via generative language model 204 (e.g., Flan-UL2, Falcon-40B, or any generative language model) based on a set of data (e.g., training data 216) and a prompt provided by language model fine-tuning component 208. For example, the prompt can include a set of exemplars for the generative language model where each exemplar in includes a keyword, a document corresponding to the keyword, and a natural language query corresponding to the keyword and the document. The set of data can include a set of keywords and a corresponding set of documents related to the keywords. In this regard, the generative language model 204 will generate natural language queries based on the set of data in accordance with the natural language queries of the exemplars.

Language model 206 is fine-tuned into a fine-tuned language model by language model fine-tuning component 208 using the set of natural language text snippets (e.g., queries) and the set of data as training data. The fine-tuned embeddings of the fine-tuned language model can be stored in data store 218. For example, the set of natural language queries generated by the generative language model 204 can be used along with the corresponding set of documents to fine-tune language model 206. In embodiments, some of the natural language queries and corresponding documents are used as training sets to fine-tune the language model 206 and some of the natural language queries and corresponding documents are used as validation sets to fine-tune the language model 206. In some embodiments, the fine-tuning by language model fine-tuning component 208 uses SBERT.

A set of independent natural language text snippets (e.g., queries) is generated via generative language model 204 based on the set of data (e.g., training data 216), such as through a different generative language model and/or a different prompt from evaluation component 210. In embodiments, each independent natural language text snippet (e.g., query) of the set of independent natural language text snippets (e.g., queries) from evaluation component 210 is different than each corresponding natural language text snippet (e.g., query) of the set of natural language text snippets (e.g., queries) from language model fine-tuning component 208. For example, a prompt that is different than an initial prompt used to generate the set of natural language queries is utilized to generate different natural language queries based on the same set of keywords and corresponding documents as used to generate the initial set of natural language queries to fine-tune language model. For example, the prompt to generate the set of independent natural language queries can include a set of different exemplars for the generative language model 204 where the natural language query of each exemplar is different than the natural language query of each exemplar described used to generate the initial set of natural language queries to fine-tune language model 206. In this regard, each exemplar can include (1) a keyword corresponding to the same keyword as the exemplar used to generate the initial set of natural language queries to fine-tune language model 206, (2) a document corresponding to the same document as the exemplar used to generate the initial set of natural language queries to fine-tune language model 206, and/or (3) a natural language query corresponding to the keyword and the document that is different than the natural language query of the exemplar used to generate the initial set of natural language queries to fine-tune language model 206. The set of data can include the same set of keywords and corresponding set of documents related to the keywords used to generate the initial set of natural language queries to fine-tune language model 206. In this regard, as the natural language queries of the exemplars of the prompt are different, the generative language model 204 will generate natural language queries based on the set of data that are different than the natural language queries used to generate the initial set of natural language queries to fine-tune language model 206.

An evaluation metric (e.g., evaluation metric 212) of the fine-tuned language model is generated via evaluation component 210 based on the set of independent natural language text snippets (e.g., queries) from generative language model 204 and the set of data (e.g., training data 216). For example, the evaluation metric can provide the accuracy of the fine-tuned language model 206 with respect to the set of independent natural language queries that are different than the natural language queries that were used to train the model to provide a more realistic measurement of the fine-tuned language model. In this regard, the set of independent natural language queries is utilized along with the set of data as a test set to generate the evaluation metric via evaluation component 210. The evaluation metric of the fine-tuned language model 206 can include any evaluation metric or combination of evaluation metrics, such as accuracy, precision, recall, Hit@K, MRR, and NDCG, or any other metric regarding the language model.

The evaluation metric generated by evaluation component 210 regarding the fine-tuned language model 206 can be displayed through a user interface component 214 (e.g., through application 110 via a display screen of the user device 102 of FIG. 1). In this regard, a more realistic measurement of the fine-tuned language model 206 that accounts for natural language variation can be presented to the user so that the user can decide whether to implement the fine-tuned language model or re-train/fine-tune the language model 206 based on further training data.

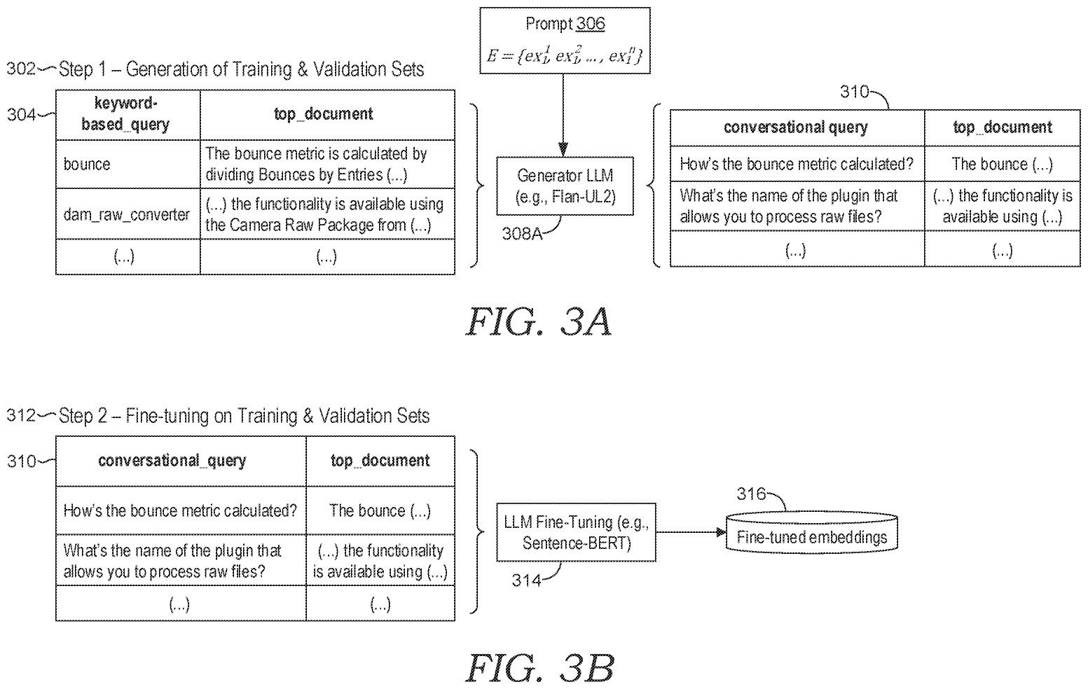

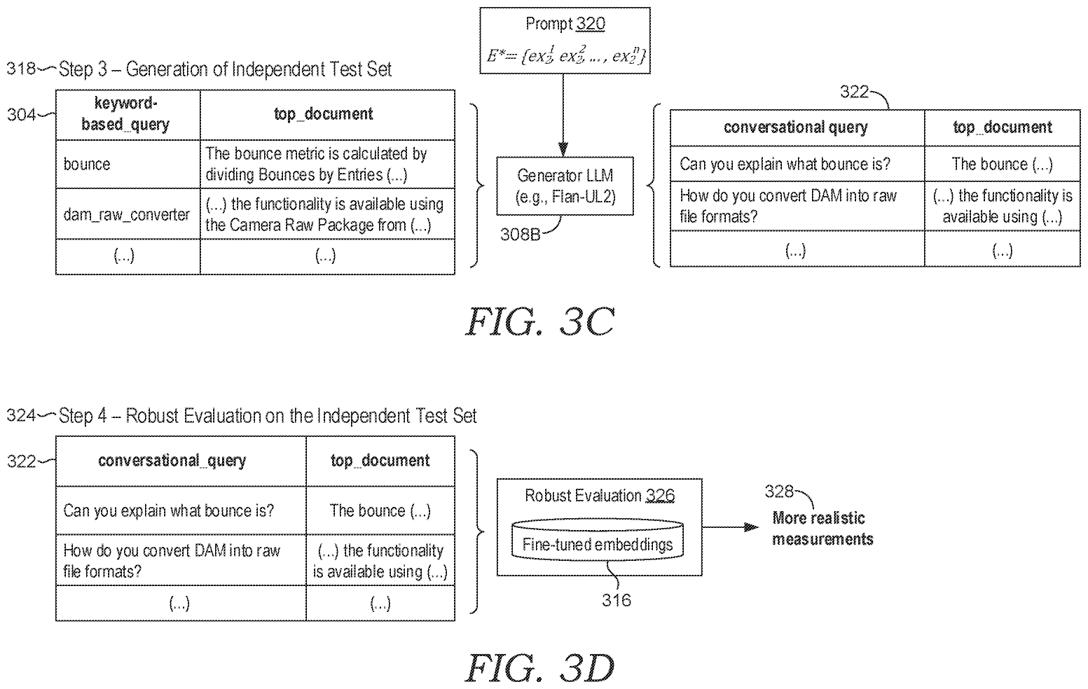

FIGS. 3A-3D provide example diagrams of using generative AI to evaluate fine-tuned language models, in accordance with embodiments of the present disclosure. At a high level, different natural language text snippets (e.g., queries) generated by a generative language model regarding the same set of data can be efficiently and effectively utilized to fine-tune a language model and provide a more robust evaluation of fine-tuned language models to natural language variation.

As shown in FIG. 3A, at step 1 302, training and validations sets are generated by a generative language model in order to fine-tune a language model (e.g., step 2 312 of FIG. 3B). In some embodiments, a set of data 304, including a set of keywords (e.g., q_{kw}) and a set of documents (e.g., docₜₒₚ), where each keyword in the set of keywords corresponds to a specific document in the set of documents. A generator LLM 308A (e.g., Flan-UL2 or any other LLM) is used to obtain a set of data 310 that includes a set of conversational queries where each conversational query corresponds to each document in the set of documents (e.g., <q_{conv}, docₜₒₚ>) for each instance in the keyword-based queries and top document set given as input (e.g., <q_{kw}, docₜₒₚ>). In some embodiments, the keywords can be extracted using a keyword extraction algorithm. In some embodiments, the keyword can be annotated by a programmer. In this regard, the set of data 304 is provided to the generator LLM 308A along with prompt 306.

In the example provided in FIG. 3A, given the keyword-based query “bounce” and the top document describing a so-called “bounce metric,” generator LLM 308A is used to generate the conversational query “How's the bounce metric calculated?.” In some embodiments, generator LLM 308A is prompted with a fixed set of exemplars in prompt 306 composed of triplets <q_{kw}, docₜₒₚ, q_{conv}> demonstrating how to transform q_{kw} into q_{conv} based on docₜₒₚ. In this regard, the set of exemplars of prompt 306 is then followed by a particular instance from the keyword-based queries and top document set, that is:

$$G ( E , {q}_{kw} , {doc}_{top} ) \to {q}_{conv} ,$$

$$In which E = \{ < {q}_{kw}^{1} , {doc}_{top}^{1} , {q}_{conv}^{1} > , ... , < {q}_{kw}^{n} , {doc}_{top}^{n} , {q}_{conv}^{n} > \} .$$

where E refers to the fixed set of exemplars of prompt 306 and G refers to generator LLM 308A.

In some embodiments, the cardinality of E depends on the LLM. In some embodiments, the range of elements of E can be 5≤n≤10.

As a more specific example, set of exemplars E of prompt 306 where E=[e1, e2, e3 . . . en] can include the following:
e1: [Keyword query: “A”, Reference: “Doc A”, Conversational query: “Conversational A”]
e2: [Keyword query: “B”, Reference: “Doc B”, Conversational query: “Conversational B”]
e3: [Keyword query: “C”, Reference: “Doc C”, Conversational query: “Conversational C”]
. . .
en: [Keyword query: “n”, Reference: “Doc n”, Conversational query: “Conversational n”]

With respect to the example shown in FIG. 3A, the set of data 304 provided to generator LLM 308A can include:
Keyword query: “bounce” (e.g., the keyword to be used to generate a conversational query),
Reference: “The bounce metrics calculated by dividing ( . . . )” (e.g., the reference document for the keyword to be used to generate the conversational query),
Conversational query: <blank> (e.g., the conversational query is left blank for the LLM (e.g., generator LLM 308A) to generate).

Further, with respect to the example shown in FIG. A3, the set of data 310 generated by generator LLM 308A:

FlanUL2 (“bounce”, “The bounce metrics calculated by dividing ( . . . )”)=“How's the bounce metric calculated?”

In this regard, the generator LLM 308A generates natural language queries (e.g., in set of data 310) based on the set of data 304 and prompt 306.

In the example provided in FIG. 3B, at step 2 312, a language model is fine-tuned using the set of data 310 generated by language model 308A. In this regard, given the set of data 310, including the set of generated conversational queries along with the top documents that were generated from step 1 302 of FIG. 3A (e.g., <q_{conv}, docₜₒₚ>), an LLM 314 is fine-tuned (e.g., using SBERT or any other base model for fine-tuning a language model) using the set of data 310 to obtain the set of fine-tuned embeddings 316.

For example, given the training and validation datasets of the set of data 310 generated through step 1 302 of FIG. 3A, LLM 314 is a retrieval model that is fine-tuned (e.g., fine-tuned embeddings 316) to learn to bridge the conversational query “How's the bounce metric calculated?” to the top document describing what “bounce metric” is. As a more specific example, the set of data 310 can include n data points where 70% of the n data points of the set of data 310 are utilized as a training set to fine-tune the language model (e.g., by generating fine-tuned embeddings 316) and 30% of the n data points of the set of data 310 are utilized as a validation set to generate error measurements/evaluation metrics of the fine-tuned language model (e.g., accuracy, precision, recall, Hit@K, MRR, and NDCG).

In the example provided in FIG. 3C, at step 3 318, an independent test set of data 322 is generated to evaluate the fine-tuned language model (e.g., fine-tuned embeddings 316) at step 4 324 of FIG. 3D. For example, at step 3 318 of FIG. 3C, given the same keyword-based queries and top-document pairs of the set of data 304 used in step 1 302 of FIG. 3A, an independent test set 322 is generated using a different generator LLM 308B (e.g., a different generator LLM and/or a different prompt to the generator LLM 308A, etc.). In this regard, given the same keyword-based queries and top-document pairs of the set of data 304 along with the generator LLM 308B, a completely disjoint and independent set of conversational and top-document pairs is generated for the set of data 322. In some embodiments, the set of data 322 is used as a test set in step 4 324. For example, where the set of data 304 and/or the set of data 310 include an n number of data points, the n number of data points of independent test set 322 generated in step 3 318 can be utilized in step 4 324 as a test set to generate error measurements/evaluation metrics (e.g., accuracy, precision, recall, Hit@K, MRR, and NDCG) of the fine-tuned language model (e.g., fine-tuned embeddings 316).

In the example shown in FIG. 3A, for step 1 302 and with respect to the set of data 304, for the <q_{kw}, docₜₒₚ> pair <“bounce”, “The bounce metric is calculated by dividing Bounces by Entries ( . . . )”>, in step 1 302 the conversational query and top-document pair <“How's the bounce metric calculated?”, “The bounce metric is calculated by dividing Bounces by Entries ( . . . )”> is generated. For step 3 318 of FIG. 3C and with respect to the set of data 304, for the <q_{kw}, docₜₒₚ> pair <“bounce”, “The bounce metric is calculated by dividing Bounces by Entries ( . . . )”>, in step 3 318 the conversational query and top-document pair <“Can you explain what bounce is?”, “The bounce metric is calculated by dividing Bounces by Entries ( . . . )”> is generated that is different than the conversational query and top-document pair of step 1 302 of FIG. 3A.

In some embodiments, generator LLM 308B is different than generator LLM 308A by prompting generator LLM 308B with a fixed set of exemplars of prompt 320 that are different than the fixed set of exemplars of prompt 306. In this regard, all triplets from the fixed set of exemplars of prompt 320 are different from the triplets from the fixed set of examples of prompt 306—even though the exemplars of prompt 320 and exemplars of prompt 306 both demonstrate the same task:

G*(E*,q_{kw},docₜₒₚ)=>q_{conv}, in which E [symbol] E*=Ø.

where E* refers to the fixed set of exemplars of prompt 320 and G* refers to generator LLM 320.

As a more specific example, with respect to the more specific example of step 3 318 of FIG. 3C, the set of exemplars E* of prompt 320 where E*=[e*1, e*2, e*3 . . . e*n] can include the following:
e*1: [Keyword query: “A”, Reference: “Doc A”, Conversational query: “Conversational A*”]
e*2: [Keyword query: “B”, Reference: “Doc B”, Conversational query: “Conversational B*”]
e*3: [Keyword query: “C”, Reference: “Doc C”, Conversational query: “Conversational C*”]
. . .
e*n: [Keyword query: “n”, Reference: “Doc n”, Conversational query: “Conversational n*”]

As can be understood, the conversational queries of the set of exemplars E* of prompt 320 (e.g., Conversational A*, Conversational B*, Conversational C* . . . Conversational n*) are different than the conversational queries of the set of exemplars E of prompt 308A (e.g., Conversational A, Conversational B, Conversational C . . . Conversational n), but the keyword queries and references remain the same. In this regard, the conversational queries of the set of data 322 generated by generator LLM 308B will be different than the conversation queries of the set of data 310 generated by generator LLM 308A.

In this regard, the set of data 304 provided to generator LLM 320 at step 3 318 of FIG. 3C can include the same set of data provided to generator LLM 308A at step 1 302 of FIG. 3A:
Keyword query: “bounce” (e.g., the keyword to be transformed),
Reference: “The bounce metrics calculated by dividing ( . . . )” (e.g., the Reference Document for the keyword to be transformed),
Conversational query: <blank> (e.g., the conversational query is left blank for the LLM to generate).

As described above, the set of data 322 generated by generator LLM 308B will be different than the set of data 310 generated by generator LLM 308A:
FlanUL2 (“bounce”, “The bounce metrics calculated by dividing ( . . . )”)=“Can you explain what bounce is?”

In the example provided in FIG. 3D, at step 4 324, the independent test set 322 generated in step 3 318 of FIG. 3C is used to provide a robust evaluation 326 of the fine-tuned language model (e.g., fine-tuned embeddings 316) for natural language variation to provide more realistic measurements 328 of the fine-tuned language model. For example, measurements 328 can include any evaluation metric or combination of evaluation metrics, such as accuracy, precision, recall, Hit@K, MRR, and NDCG, or any other metric regarding the language model.

As an example, in order to generate the fine-tuned embeddings 316 at step 2 312 of FIG. 3B, the training process includes detecting an error and correcting the error to generate the fine-tuned embeddings 316. A validation set from the set of data 310 is used to determine measurements of the fine-tuned embeddings 316. For example, the measurements of the fine-tuned embeddings 316 at step 2 312 of FIG. 3B may include that the precision of the model is 90%. The set of data 322 at step 4 324 of FIG. 3D can be used (e.g., as a test set) to detect the error of the fine-tuned embeddings using the natural language variation in the set of data 322. For example, the measurements of the fine-tuned embeddings 316 at step 4 324 of FIG. 3D may include that the precision of the model is 80% based on the natural language variation of the set of data 322, and not 90% as previously determined at step 2 312 of FIG. 3B. In this regard, more realistic measurements (e.g., measurements 326) are provided regarding the fine-tuned language model (e.g., fine-tuned embeddings 316) to account for natural language variation.

### Exemplary Implementation of Using Generative AI to Evaluate Fine-Tuned Language Models

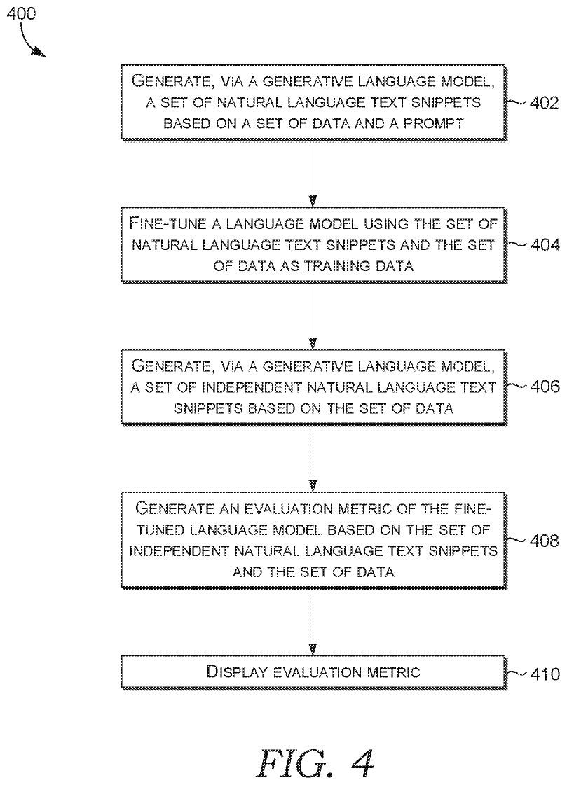

With reference now to FIG. 4, a flow diagram is provided showing exemplary method 400 related to using generative AI to evaluate fine-tuned language models, in accordance with embodiments of the present technology. Each block of method 400 comprises a computing process that can be performed using any combination of hardware, firmware, and/or software. For instance, various functions can be carried out by a processor executing instructions stored in memory. The method can also be embodied as computer-usable instructions stored on computer storage media. The method can be provided by a standalone application, a service or hosted service (standalone or in combination with another hosted service), or a plug-in to another product, to name a few. The method flow of FIG. 4 are exemplary only and not intended to be limiting. As can be appreciated, in some embodiments, method flow 400 can be implemented, at least in part, to facilitate using generative AI to evaluate fine-tuned language models in order to provide a more robust evaluation of a fine-tuned language model to natural language variation.

Turning initially to FIG. 4, a flow diagram is provided showing an embodiment of a method 400 for using generative AI to evaluate fine-tuned language models in accordance with embodiments described herein. Such use of generative AI to evaluate fine-tuned language models can be used to efficiently and effectively provide a more robust evaluation of a fine-tuned language model by generating more realistic measurements of the fine-tuned language model to natural language variation.

Initially, at block 402, a set of natural language text snippets, such as a set of natural language queries, is generated via a generative language model based on a set of data. For example, a prompt to the generative language model can include a set of exemplars for the generative language model where each exemplar in includes a keyword, a document corresponding to the keyword, and a natural language query corresponding to the keyword and the document. The set of data can include a set of keywords and a corresponding set of documents related to the keywords. In this regard, the generative language model will generate natural language queries based on the set of data in accordance with the natural language queries of the exemplars.

At block 404, a language model is fine-tuned into a fine-tuned language model using the set of natural language text snippets (e.g., queries) and the set of data as training data. For example, the set of natural language queries generated by the generative language model at block 402 can be used along with the corresponding set of documents to fine-tune a language model. In embodiments, some of the natural language queries and corresponding documents are used as training sets to fine-tune the language model and some of the natural language queries and corresponding documents are used as validation sets to fine-tune the language model. In some embodiments, the fine-tuning uses SBERT.

At block 406, a set of independent natural language text snippets, such as a set of independent natural language queries, is generated via a generative language model based on the set of data, such as through a different generative language model and/or a different prompt. In embodiments, each independent natural language text snippet of the set of independent natural language text snippets is different than each corresponding natural language text snippet of the set of natural language snippets. For example, a prompt that is different than an initial prompt used to generate the set of natural language queries is utilized to generate the different natural language queries based on the same set of keywords and corresponding documents as used in block 402. For example, the prompt to generate the set of independent natural language queries can include a set of different exemplars for the generative language model where the natural language query of each exemplar is different than the natural language query of each exemplar described in block 402. In this regard, each exemplar includes a keyword corresponding to the same keyword as the exemplar of block 402, a document corresponding to the same document as the exemplar of block 402, and a natural language query corresponding to the keyword and the document that is different than the natural language query of the exemplar of block 402. The set of data can include the same set of keywords and corresponding set of documents related to the keywords as block 402. In this regard, as the natural language queries of the exemplars of the prompt are different, the generative language model will generate natural language queries based on the set of data that are different than the natural language queries generated at block 402.

At block 408, an evaluation metric of the fine-tuned language model is generated based on the set of independent natural language text snippets (e.g., queries) and the set of data. For example, the evaluation metric can provide the accuracy of the fine-tuned language model with respect to the set of independent natural language queries that are different than the natural language queries that were used to train the model to provide a more realistic measurement of the fine-tuned language model. In this regard, the set of independent natural language queries is utilized along with the set of data as a test set to generate the evaluation metric. The evaluation metric of the fine-tuned language model can include any evaluation metric or combination of evaluation metrics, such as accuracy, precision, recall, Hit@K, MRR, and NDCG, or any other metric regarding the language model.

At block 410, the evaluation metric is displayed regarding the fine-tuned language model. For example, the evaluation metric of the fine-tuned language model can be displayed via a user interface component through a display screen of a user device. In this regard, a more realistic measurement of the fine-tuned language model that accounts for natural language variation can be presented to the user so that the user can decide whether to implement the fine-tuned language model or re-train/fine-tune the language model based on further training data.

### Overview of Exemplary Operating Environment

Having briefly described an overview of aspects of the technology described herein, an exemplary operating environment in which aspects of the technology described herein may be implemented is described below in order to provide a general context for various aspects of the technology described herein.

Referring to the drawings in general, and initially to FIG. 5 in particular, an exemplary operating environment for implementing aspects of the technology described herein is shown and designated generally as computing device 500. Computing device 500 is just one example of a suitable computing environment and is not intended to suggest any limitation as to the scope of use or functionality of the technology described herein. Neither should the computing device 500 be interpreted as having any dependency or requirement relating to any one or combination of components illustrated.

The technology described herein may be described in the general context of computer code or machine-usable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Aspects of the technology described herein may be practiced in a variety of system configurations, including handheld devices, consumer electronics, general-purpose computers, and specialty computing devices. Aspects of the technology described herein may also be practiced in distributed computing environments where tasks are performed by remote-processing devices that are linked through a communications network.

With continued reference to FIG. 5, computing device 500 includes a bus 510 that directly or indirectly couples the following devices: memory 512, one or more processors 514, one or more presentation components 516, input/output (I/O) ports 518, I/O components 520, an illustrative power supply 522, and a radio(s) 524. Bus 510 represents what may be one or more busses (such as an address bus, data bus, or combination thereof). Although the various blocks of FIG. 5 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors hereof recognize that such is the nature of the art, and reiterate that the diagram of FIG. 5 is merely illustrative of an exemplary computing device that can be used in connection with one or more aspects of the technology described herein. Distinction is not made between such categories as “workstation,” “server,” “laptop,” and “handheld device,” as all are contemplated within the scope of FIG. 5 and refer to “computer” or “computing device.”

Computing device 500 typically includes a variety of computer-readable media. Computer-readable media can be any available media that can be accessed by computing device 500 and includes both volatile and nonvolatile, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program sub-modules, or other data.

Computer storage media includes RAM, ROM, EEPROM, flash memory or other memory technology, CD-ROM, digital versatile disks (DVD) or other optical disk storage, magnetic cassettes, magnetic tape, magnetic disk storage, or other magnetic storage devices. Computer storage media does not comprise a propagated data signal.

Communication media typically embodies computer-readable instructions, data structures, program sub-modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

Memory 512 includes computer storage media in the form of volatile and/or nonvolatile memory. The memory 512 may be removable, non-removable, or a combination thereof. Exemplary memory includes solid-state memory, hard drives, and optical-disc drives. Computing device 500 includes one or more processors 514 that read data from various entities such as bus 510, memory 512, or I/O components 520. Presentation component(s) 516 present data indications to a user or other device. Exemplary presentation components 516 include a display device, speaker, printing component, and vibrating component. I/O port(s) 518 allow computing device 500 to be logically coupled to other devices including I/O components 520, some of which may be built in.

Illustrative I/O components include a microphone, joystick, game pad, satellite dish, scanner, printer, display device, wireless device, a controller (such as a keyboard, and a mouse), a natural user interface (NUI) (such as touch interaction, pen (or stylus) gesture, and gaze detection), and the like. In aspects, a pen digitizer (not shown) and accompanying input instrument (also not shown but which may include, by way of example only, a pen or a stylus) are provided in order to digitally capture freehand user input. The connection between the pen digitizer and processor(s) 514 may be direct or via a coupling utilizing a serial port, parallel port, and/or other interface and/or system bus known in the art. Furthermore, the digitizer input component may be a component separated from an output component such as a display device, or in some aspects, the usable input area of a digitizer may be coextensive with the display area of a display device, integrated with the display device, or may exist as a separate device overlaying or otherwise appended to a display device. Any and all such variations, and any combination thereof, are contemplated to be within the scope of aspects of the technology described herein.

A NUI processes air gestures, voice, or other physiological inputs generated by a user. Appropriate NUI inputs may be interpreted as ink strokes for presentation in association with the computing device 500. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 500. The computing device 500 may be equipped with depth cameras, such as stereoscopic camera systems, infrared camera systems, RGB camera systems, and combinations of these, for gesture detection and recognition. Additionally, the computing device 500 may be equipped with accelerometers or gyroscopes that enable detection of motion. The output of the accelerometers or gyroscopes may be provided to the display of the computing device 500 to render immersive augmented reality or virtual reality.

A computing device may include radio(s) 524. The radio 524 transmits and receives radio communications. The computing device may be a wireless terminal adapted to receive communications and media over various wireless networks. Computing device 500 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include a Wi-Fi® connection to a device (e.g., mobile hotspot) that provides access to a wireless communications network, such as a WLAN connection using the 802.11 protocol. A Bluetooth connection to another computing device is a second example of a short-range connection. A long-range connection may include a connection using one or more of CDMA, GPRS, GSM, TDMA, and 802.16 protocols.

The technology described herein has been described in relation to particular aspects, which are intended in all respects to be illustrative rather than restrictive. The technology described herein is described with specificity to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and “block” may be used herein to connote different elements of methods employed, the terms should not be interpreted as implying any particular order among or between various steps herein disclosed unless and except when the order of individual steps is explicitly described.

1. A computer-implemented method comprising:
generating, via a generative language model, a set of natural language text snippets based on a corresponding set of data;
fine-tuning, via a language model fine-tuning component, a language model into a fine-tuned language model using the set of natural language text snippets and the corresponding set of data as training data;
generating, via the generative language model, a set of independent natural language text snippets based on the corresponding set of data, each independent natural language text snippet of the set of independent natural language text snippets being different than each corresponding natural language text snippet of the set of natural language text snippets; and
generating, via an evaluation component, an evaluation metric of the fine-tuned language model based on the set of independent natural language text snippets and the corresponding set of data.

2. The computer-implemented method of claim 1, wherein the corresponding set of data comprises a set of documents and generating the set of natural language text snippets further comprises:
receiving a set of keywords and the corresponding set of documents, each keyword of the set of keywords corresponding to each document of the set of documents; and
generating each natural language text snippet of the set of natural language text snippets based on the set of keywords and the corresponding set of documents.

3. The computer-implemented method of claim 1, wherein generating the set of natural language text snippets further comprises:
receiving a prompt, the prompt comprising a set of exemplars, each exemplar in the set of exemplars comprising a keyword, a document corresponding to the keyword, and a natural language text snippet corresponding to the keyword and the document; and
generating each natural language text snippet of the set of natural language text snippets based on the prompt.

4. The computer-implemented method of claim 1, wherein generating the set of independent natural language text snippets further comprises:
receiving a prompt that is different than an initial prompt used to generate the set of natural language text snippets; and
generating each independent natural language text snippet of the set of independent natural language text snippets based on the prompt.

5. The computer-implemented method of claim 1, wherein each natural language text snippet of the set of natural language text snippets and each independent natural language text snippet of the set of independent natural language text snippets are natural language queries.

6. The computer-implemented method of claim 1, wherein the fine-tuning uses Sentence Bidirectional Encoder Representations from Transformers (SBERT).

7. The computer-implemented method of claim 1, wherein the evaluation metric comprising at least one of accuracy, precision, recall, Hit@K, Mean Reciprocal Rank (MRR), and Normalized Discounted Cumulative Gain (NDCG).

8. The computer-implemented method of claim 1, wherein the set of independent natural language text snippets and the corresponding set of data is a test set of data.

9. A non-transitory computer-readable medium storing executable instructions, which when executed by a processing device, cause the processing device to perform operations comprising:
prompting, via a language model fine-tuning component, a generative language model to generate a set of natural language text snippets based on a set of keywords and a corresponding set of documents, each keyword of the set of keywords corresponding to each document of the set of documents;
fine-tuning, via the language model fine-tuning component, a language model into a fine-tuned language model using the set of natural language text snippets and the corresponding set of documents as training data;
prompting, via the language model fine-tuning component, a generative language model to generate a set of independent natural language text snippets based on the set of keywords and the corresponding set of documents, each independent natural language text snippet of the set of independent natural language text snippets being different than each corresponding natural language text snippet of the set of natural language text snippets; and
generating, via an evaluation component, an evaluation metric of the fine-tuned language model based on the set of independent natural language text snippets and the corresponding set of documents.

10. The media of claim 9, wherein prompting the generative language model to generate the set of natural language text snippets further comprises:
generating a prompt, the prompt comprising a set of exemplars, each exemplar in the set of exemplars comprising a keyword, a document corresponding to the keyword, and a natural language text snippet corresponding to the keyword and the document; and
prompting the generative language model to generate each natural language text snippet of the set of natural language text snippets based on the prompt.

11. The media of claim 9, wherein prompting the generative language model to generate the set of independent natural language text snippets further comprises:
generating a prompt that is different than an initial prompt used to generate the set of natural language text snippets; and
prompting the generative language model to generate each independent natural language text snippet of the set of independent natural language text snippets based on the prompt.

12. The media of claim 9, wherein each natural language text snippet of the set of natural language text snippets and each independent natural language text snippet of the set of independent natural language text snippets are natural language queries.

13. The media of claim 9, wherein the fine-tuning uses Sentence Bidirectional Encoder Representations from Transformers (SBERT).

14. The media of claim 9, wherein the evaluation metric comprising at least one of accuracy, precision, recall, Hit@K, Mean Reciprocal Rank (MRR), and Normalized Discounted Cumulative Gain (NDCG).

15. A computing system comprising:
a processor; and
a non-transitory computer-readable medium having stored thereon instructions that when executed by the processor, cause the processor to perform operations including:
trigger-generating, via a generative language model, a set of natural language queries based on a set of keywords and a corresponding set of documents, each keyword of the set of keywords corresponding to each document of the set of documents;
trigger-generating, via a language model fine-tuning component, a fine-tuned language model from a language model using the set of natural language queries and the corresponding set of documents as training data;
trigger-generating, via the generative language model, a set of independent natural language queries based on the set of keywords and the corresponding set of documents, each independent natural language query of the set of independent natural language queries being different than each corresponding natural language query of the set of natural language queries;
trigger-generating, via an evaluation component, an evaluation metric of the fine-tuned language model based on the set of independent natural language queries and the corresponding set of documents; and
causing display of the evaluation metric.

16. The system of claim 15, wherein trigger-generating the set of natural language queries further comprises:
receiving a prompt, the prompt comprising a set of exemplars, each exemplar in the set of exemplars comprising a keyword, a document corresponding to the keyword, and a natural language query corresponding to the keyword and the document; and
generating each natural language query of the set of natural language queries based on the prompt.

17. The system of claim 15, wherein trigger-generating the set of independent natural queries further comprises:
receiving a prompt that is different than an initial prompt used to generate the set of natural language queries; and
generating each independent natural language query of the set of independent natural language queries based on the prompt.

18. The system of claim 15, wherein the fine-tuned language model is generated using Sentence Bidirectional Encoder Representations from Transformers (SBERT).

19. The system of claim 15, wherein the evaluation metric comprising at least one of accuracy, precision, recall, Hit@K, Mean Reciprocal Rank (MRR), and Normalized Discounted Cumulative Gain (NDCG).

20. The system of claim 15, wherein the set of independent natural language queries and the corresponding set of documents is a test set of data.
